(19) United States
(12) Patent Application Publication
(10) Pub. No.: US 2025/0059078 A1
(43) Pub. Date: Feb. 20, 2025

(54) HUMAN WASTE COLLECTION AND SEPARATION SYSTEM

(71) Applicant: Georgia Tech Research Corporation, Atlanta, GA (US)

(72) Inventors: Shannon YEE, Decatur, GA (US); Harald GRUENDL, Vienna (AT); Georg SAMPL, Vienna (AT); Oscar Estrada LEÓN, Vienna (AT); Roland LEHMANN, Gossau (CH); Janine GLATTHARD, Wil (CH); Mathias SCHLAURI, Wil (CH)

(21) Appl. No.: 18/578,235

(22) PCT Filed: Jul. 15, 2022
(86) PCT No.: PCT/US2022/037398

§ 371 Date: Jan. 10, 2024

Related U.S. Application Data
(60) Provisional application No. 63/338,998, filed on May 6, 2022.

(51) Int. Cl. C02F 11/128; C02F 103/00; E03D 5/014

(52) U.S. Cl. CPC C02F 11/128; E03D 5/014; C02F 2103/005; C02F 2201/005; C02F 2201/007; C02F 2301/026; C02F 2301/063

(57) ABSTRACT

System and method for collection and separation of human waste are described. The system can include a vessel (102) configured to receive human waste and a solids separator (106). The solids separator can include a vacuum tank as well as an inlet chamber formed within the vacuum tank at the top portion, a solids containment portion formed in the base of the vacuum tank and positioned centrally within the vacuum tank, a liquid containment portion formed in the base of the vacuum tank and contained within the vacuum tank surrounding the solids containment portion, and a separating filter having a cylindrical tubular shape and extending from the inlet chamber outlet to the solids containment portion. The separating filter forming a central separation volume within the vacuum tank. The inlet chamber is configured to receive the combined waste via an inlet (132) and to direct the combined waste to the central separation volume. The liquid portion of the combined waste allowed to flow through the separating filter to an outer portion surrounding the central separation volume and to collect in the liquid containment portion of the base. The solids portion of the combined waste contained within the central separation volume and collected in the solids containment portion of the base.

### CROSS-REFERENCE TO RELATED APPLICATION

This application claims the benefit of and priority to U.S. Provisional Application No. 63/338,998, titled “HUMAN WASTE COLLECTION AND SEPARATION SYSTEM,” filed on May 6, 2022, the entire contents of which are hereby incorporated herein by reference.

### BACKGROUND

An estimated 4.5 billion people worldwide do not have access to safe, affordable sanitation systems. High levels of child death and disease have been linked to oral fecal contamination where pathogen laden fecal matter enters the food or water supply. Non-sewered sanitation systems are needed where traditional sanitary sewer systems are unavailable or impractical.

### SUMMARY

Disclosed herein is a solids separator for separating a combined human waste, the solids separator comprising a vacuum tank having a top portion, a base, and a cylindrical wall and comprising an inlet chamber, a solids containment portion, a liquid containment portion, and a separating filter.

The inlet chamber is formed within the vacuum tank at the top portion and comprises an inlet and a chamber outlet. The inlet chamber is configured to receive the combined waste via an inlet such that the combined waste is guided in a spiral about an interior surface of the inlet chamber and directed to a central separation volume. The liquid portion of the combined waste is allowed to flow through the separating filter to an outer portion surrounding the central separation volume and collect in the liquid containment portion of the base, while the solids portion of the combined waste is contained within the central separation volume and collected in the solids containment portion of the base.

The solids containment portion is formed in the base of the vacuum tank and positioned centrally within the vacuum tank and comprises a solids outlet. The solids containment portion is configured to hold a separated solids portion of the combined waste.

The liquid containment portion is formed in the base of the vacuum tank and contained within the vacuum tank surrounding the solids containment portion. The liquid containment portion comprises a liquids outlet and the liquid containment portion is configured to hold a separated liquid portion of the combined waste.

The separating filter has a cylindrical tubular shape and extends from the chamber outlet to the solids containment portion. The separating filter forms a central separation volume within the volume tank.

Also disclosed herein are methods for separating a combined human waste using the disclosed solids separator.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIGS. 1A and 1B illustrate schematic diagrams of example human waste collection and separation systems according to various embodiments described herein.

FIG. 2 illustrates an example solids separator for a human waste collection and separation system shown in FIGS. 1A and 1B according to various embodiments described herein.

FIG. 3 illustrates a cross section of a frontend solids separator of FIG. 2 according to various embodiments described herein.

FIG. 4 illustrates the separation of the solids and liquid within the solids separator of FIG. 2 according to various embodiments described herein.

FIG. 5 illustrates an example method for human waste collection and separation according to various embodiments described herein.

FIG. 6 illustrates one example schematic of the human waste collection and separation system used as a module within a non-sewered single unit toilet system according to various embodiments described herein.

FIG. 7 illustrates another example schematic of the human waste collection and separation system used as a module within a non-sewered single unit toilet system according to various embodiments described herein.

### DETAILED DESCRIPTION

Sanitation systems are needed for regions of the world where open defecation or lack of improved sanitation is common, which can lead to illness. Traditional sewage and wastewater treatment plants which receive waste from sewers can be expensive to implement and operate. Technologies for multi-unit toilets are being developed to process waste on a large scale. However, there is a need for technology to provide access to safe, affordable sanitation systems that can be deployed in a family home without sewer connections. Holistically, as water scarcity rises across the globe, sanitation systems that reduce reliance on large volumes of water for transport of waste over long distances will become increasingly important, not just in developing countries, but globally.

To address these deficiencies, systems for use in a stand-alone non-sewered toilet system are discussed herein. The systems can be configured to inactivate pathogens from human waste and prepare the waste for safe disposal. The systems can also recover valuable resources such as clean water. The systems can be configured to operate without connection to input water or output sewers. Some example systems can be battery based or powered by off-grid renewables. The systems can be optimized for low-cost fabrication and low operation costs. The systems can promote sustainable sanitation services that operate in poor, urban settings, as well as in developed and developing nations.

The ISO 30500 standard provides a technical standard for non-sewered sanitation systems designed to address basic sanitation needs and promote economic, social, and environmental sustainability through strategies that include minimizing water and energy consumption and converting human excreta to safe output. These sanitation systems are intended to operate without connection to any sewer or drainage network and meet health and environmental safety and regulatory parameters. In some examples, systems described herein can be configured to provide treated output that meets or exceeds the ISO 30500 standard.

For example, human waste streams can include urine, feces, diarrhea, and the like. Sanitation incidentals can include toilet paper, feminine hygiene waste, diapers, other paper products, and the like. In some toilet systems, a portion of sanitation incidentals, including non-organic products such as diapers, can be received and processed separately from the human waste streams. In some examples, the wastes streams comprise human feces and urine, menstrual blood, bile, flushing water, anal cleansing water, toilet paper, other bodily fluids and/or solids. Additionally, the waste streams can comprise water, including flush water, rinse water, wash water, fresh water, consumable water, potable water, useable water, and the like.

For example, a stand-alone non-sewered toilet system can comprise a liquid treatment system and a solids treatment system, each of which can operate as a separate system or be interconnected for treatment of human waste. The stand-alone non-sewered toilet system can also comprise at least one separation system. In some examples, the content of human waste streams can be separated or processed separately. Separation of streams can provide more efficient processing than mixed-content human waste streams by dividing the source material into primarily feces, urine, and wastewater streams. Since 100% separation is not practical, a degree of cross contamination between the streams is acceptable for the subsequent downstream treatment approaches. As described herein, the feces stream, containing primarily feces, is also referred to as the “brown stream.” The brown stream is mostly feces, but can also be mixed with other liquid and solid waste. For example, the brown stream can include feces, toilet paper, some urine, and some water. As described herein, the “green stream” can include mostly water, some urine, and some toilet paper, and usually does not include feces. The green stream is mostly liquid with some solids. As described herein, the urine stream, containing primarily urine, is also referred to as the “yellow stream.” For example, a yellow stream can include urine and some water. As described herein, the wastewater stream is also referred to as the “blue stream.” For example, the blue stream can contain primarily wastewater in the form of flush water, anal rinse water, or excess water that is poured into the toilet. In some examples, the blue stream can also include some urine. Stream separation can enable lower cost and more robust treatment processes given the high degree of variability in low volume fecal deposits (recognized as primarily diarrhea), high volume urine deposits, and excessive amounts of flush and anal rinse water, given future water scarcity constraints.

In the context described above, various examples of human waste collection and separation systems and methods are described herein. The human waste collection and separation system can be a separation system that can operate separately or can be configured to integrate with another system. For example, the human waste collection and separation system can be a separation system configured for use in a stand-alone non-sewered toilet system. For example, the human waste collection and separation system can be integrated as a module for solids treatment in a stand-alone non-sewered sanitation system. In some examples, the human waste collection and separation system can be configured to operate as part of a single unit toilet system. For example, the human waste collection and separation module can be integrated for use in a single unit toilet system configured to render the bodily wastes of an adult human into water, CO₂, and mineral ash. For example, the stand-alone non-sewered sanitation system can also include a urine and wastewater treatment system and a feces treatment system.

In this context, a human waste collection and separation system can be used to receive and separate the input human waste from urination and/or defecation toilet events. The human waste collection and separation system is also referred to as a frontend separation system or a frontend module herein. For example, the human waste collection and separation system can be configured to be a frontend module for a stand-alone non-sewered single unit toilet system or another toilet system. In some aspects, the frontend module can be configured to provide the type of toilet configuration that is acceptable in a particular region of the world. For example, the human waste collection and separation system has a frontend main vessel, a toilet bowl, for collecting human waste that can be adapted for either a squat configuration or a pedestal configuration. Additionally, the human waste collection and separation system can be configured to accommodate users that wipe using toilet paper or rinse with water. The human waste collection and separation system can accommodate standing male urinators.

In the following discussion, a general description of the human waste collection and separation system and components is provided, including a discussion of the operation of the same. Non-limiting examples of a human waste collection and separation system are discussed. In some examples, the configuration can include optional connections to integrate the human waste collection and separation system with other systems. For example, the human waste collection and separation system can integrate with a stand-alone non-sewered sanitation system comprising a urine and wastewater treatment system and/or a feces treatment system. In some examples, the human waste collection and separation system provides a user input unit for an ISO-30500 compliant toilet system.

The human waste collection and separation system can process mixed human waste and separate the waste into at least two different output streams for further processing and/or treatment. The human waste combined with water and/or toilet paper can be separated into at least two streams: a mostly liquid stream and a mostly solids stream. As described above, the mostly liquid stream, also called the green stream herein, and can contain a proportionally small amount of solids. The mostly liquid stream, or green stream, can comprise flush water, some urine, some feces, and some toilet paper. As described above, the mostly solids stream, also called the brown stream herein, can contain mostly solids and some liquid. The mostly solids stream, or brown stream, can comprise feces, flush water, urine, and toilet paper. In some examples, a third output stream comprising mostly urine can be diverted prior to separating the combined waste, thus reducing the volume of combined waste to be separated. This mostly urine stream, or yellow stream, can comprise urine and trace amounts of flush water. It is noted that the yellow, green, and brown streams are defined by the composition of human waste as described herein, not by the actual color of the physical stream.

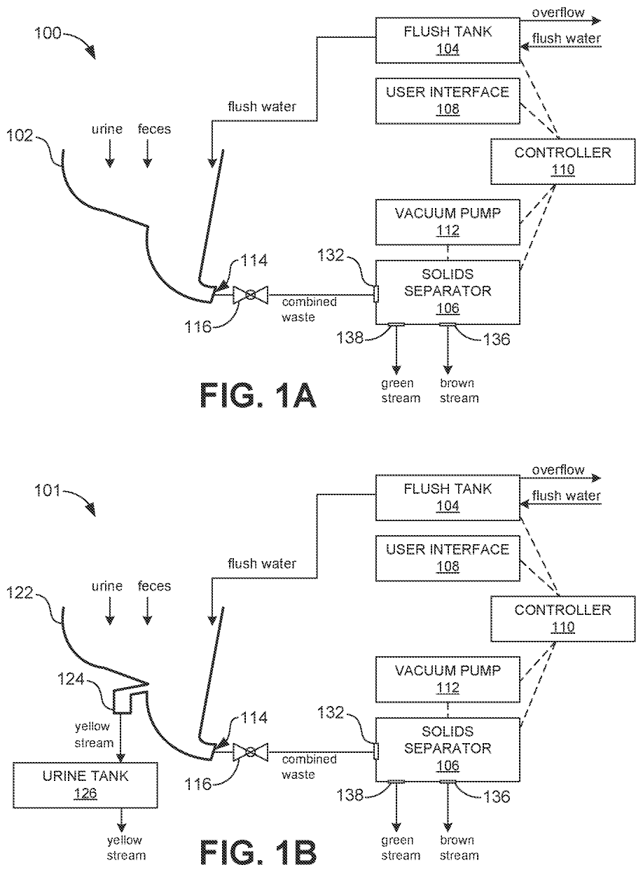

As illustrated in FIG. 1A, the human waste collection and separation system 100 can comprise a main vessel 102, a flush tank 104, and a frontend solids separator 106. The human waste collection and separation system 100 can also include a user interface panel 108, a controller 110, and a vacuum pump 112. The main vessel 102 can be a toilet bowl configured to receive human waste, such as urine and feces, as well as toilet paper. After a urination and/or defecation event, a volume of flush water, received from the flush tank 104, can be added to the main vessel 102 forming a combined waste within the vessel. The combined waste can be evacuated through a main outlet 114 of the main vessel 102 into the solids separator 106. The combined waste received into the solids separator 106 can be separated into a liquid portion comprising mostly liquids with some solids and a solids portion comprising mostly solids and some liquids. For example, in FIG. 1A, two outputs of the solids separator 106 are labeled as the green stream, which is the liquid portion, and the brown stream, which is the solids portion.

The human waste collection and separation system 100 is configured to receive human waste from a user into a main vessel 102. The main vessel 102 can be configured based on a regional preference and/or customs. In some regions of the world, users are accustomed to a squat configuration toilet. In some regions of the world, users are accustomed to a pedestal or sitting configuration toilet. The main vessel 102 can be a toilet bowl configured for either a squat or pedestal configuration. Similarly, the while the examples of combined waste herein include feces, urine, toilet paper, and/or flush water, in some regions of the world, it may not be customary to use toilet paper. For users that do not use toilet paper, human waste collection and separation system 100 and the main vessel 102 can be adapted for a rinse configuration. In a rinse configuration, the excess rinse water can also be accommodated and can be considered as added to the combined waste instead of or in addition to the flush water.

The flush tank 104 can be configured to deliver a volume of flush water to the main vessel 102. In some examples, the volume of flush water is a predetermined amount regardless of the human waste event. In some examples, the predetermined amount of flush water is based on whether the human waste received is due to a urination event or a defecation event. The flush tank 104 can be configured to receive and store water from an external system or recirculated source for use as flush water. In one example, the water for the flush tank 104 can be received from another system or module of a toilet system that interconnects with the human waste collection and separation system 100. For example, the water for the flush tank 104 can be received from a urine and wastewater treatment system or a liquid treatment module of a non-sewered toilet system. In another example, the water for the flush tank 104 can be received from a municipal water supply or other external water supply. The flush tank 104 can also be configured with an overflow outlet to divert excess water to a buffer tank or other system or module. For example, the human waste collection and separation system 100 can be a user frontend module for a single unit non-sewered toilet system that includes a urine and wastewater treatment module and/or modules to treat waste streams comprising feces. The human waste collection and separation system can be configured with an overflow output from a flush tank 104. In an example, excess water from the flush tank 104 can be routed to another buffer tank or buffer system.

The human waste collection and separation system 100 can also include a controller 110. For example, the controller 110 can include a microprocessor and memory and be configured to control or operate one or more elements of the human waste collection and separation system 100. The controller 110 can be CE compliant. The controller 110 can be configured initiate a flush sequence and to control or operate additional elements for the human waste collection and separation system 100. For example, the controller 110 can operate the vacuum pump 112, main valve 116, and additional components not shown. For example, the human waste collection and separation system 100 can also comprise valves, pumps, motors, sensors, and the like (not shown). The controller 110 can be configured to control or operate one or more valves, pumps, motors, and sensors based on an indication that user input has been received in the main vessel. For example, a sensor and/or input via the user interface panel 108 can control the operation of the vacuum pump 112 or other means to evacuate the main vessel 102. The waste from the main vessel 102 can be routed to the solids separator 106 by actuating the main valve 116. Additionally, the controller 110 can be configured to control the release of a separated liquids portion and/or separated solids portion in the vacuum tank.

As shown in FIG. 1A, a user interface panel 108 can be configured to initiate the release of a volume of flush water from the flush tank 104 into the main vessel 102. In some examples, the user interface panel 108 can include buttons or other selector options for the user to select a urination or defecation waste event to flush the toilet. For example, the selector options may include buttons, levers, switches, knobs, digital interfaces, and the like. For example, if the user deposits toilet paper during the urination event, the user can select a small flush button on the user interface panel 108 to release a first predetermined volume of water to and from the flush tank 104 to wash any residual urine and/or toilet paper and evacuate the contents of main vessel 102 to the frontend solids separator 106. Similarly, for a defecation event, the user can select a flush button on the user interface panel 108 to release a second predetermined volume of water to and from the flush tank 104 to wash the mixed waste contents and evacuate the main vessel 102 to the frontend solids separator 106. For example, the first predetermined volume of water can be a smaller amount for a urination event compared to a larger amount of the second predetermined volume of water for a defecation event.

In an example, the user interface panel 108 can have color coded buttons for identification by the user, but color is not necessary. For example, the buttons could include symbols and/or words. Further, a simplified panel may only include two buttons for a urination event and a defecation event. In a simplified example, the size of the button may indicate the type of event. For example, a smaller button may indicate a urination event to release a first predetermined volume of water, and a larger button may indicate a defecation event to release a second predetermined volume of water, which is a larger volume of water. The user interface panel 108 is not limited to the example configurations provided, as the buttons in the panel are configured to activate a signal to the controller 110 to operate a flush sequence related to the waste event. For example, the user can select a flush button on the user interface panel 108 to select the type of waste event, such as a urination or defecation event. For a waste event that includes at least toilet paper, the contents of the main vessel 102 can be routed to the solids separator 106. For example, for a human waste event, the event flush button is pressed, flush water is introduced to the main vessel 102 from the flush tank 104 to wash a mixture of residual urine, residual feces, and/or toilet paper to the bottom of the main vessel 102, which is closed off by a main valve 116, which is a two-way valve. At this time, a weak vacuum can be generated in the solids separator 106 by activation of the vacuum pump 112. For example, the vacuum pressure of the weak vacuum can be about −0.5 bar. Once a predetermined vacuum pressure is achieved, the main valve 116 can be opened and the waste transported to into the solids separator 106.

In another example, the human waste collection and separation system 100 can comprise at least one sensor configured to detect a waste event and send a signal to the controller 110 to control the flush operation to release water from the flush tank 104. In an example with at least one sensor, the user interface panel 108 can be optional, omitted, or serve as a backup secondary to the sensors. In some examples, the sensors can detect a urination or defecation event and release a first or a second predetermined volume of water accordingly.

In another example system, as shown in FIG. 1B, the alternate main vessel 122 can comprise a urine diverter 124 to provide an additional output stream comprising urine from the human waste collection and separation system 101 (system 101). System 101 is substantially the same as human waste collection and separation system 100 with a substitution of alternate main vessel 122 comprising a urine diverter 124, as well additional features to route the diverted urine stream, shown as the yellow stream in FIG. 1B. One example of a main vessel including a urine diverter is disclosed for example in PCT application No. PCT/AT2019/060064. The urine diverter can be shaped within the vessel and configured such that surface tension and cohesive effects allow the bypass portion of the liquid waste to follow the contour of the vessel to a bypass liquids outlet. With this optional feature of the alternate main vessel 122 comprising a urine diverter 124, the alternate main vessel 122 can be configured in either a squat or pedestal configuration and can be adapted for a rinse configuration, as specified for different regions of the world. The urine diverter 124 can be incorporated into the geometry of the toilet bowl design and configured to capture the urine in a passive manner. For example, a urination event or waste event comprising urine, the urine is in a liquid form, thus there is no need to separate solids. When using the alternate main vessel 122 comprising a urine diverter 124, the urine can be separated from without the use of water via a urine diverter 124.

In some examples, the urine stream output shown as the yellow stream in FIG. 1B can be temporarily stored in a urine tank 126 or routed to join the liquid output stream from the solids separator 106 or routed treatment in another module or system. For example, a urine stream from the urine tank 126 can be directed to a buffer tank separation system or a liquid treatment system. In some examples, the yellow and green streams can be transported separately to other systems or treatment modules, or combined for transport, depending on the type of toilet or treatment system to which the system 101 is connected. For example, if a treatment system can utilize or output the separated urine, the yellow and green streams can remain separate. In another example, the yellow and green streams can be combined and processed as a liquid waste stream.

As shown in FIG. 1B, the remaining features of system 101 are substantially the same as shown in human waste collection and separation system 100 of FIG. 1A. For some urination events, at least a portion of the urine can be diverted or routed separately. As described with respect to human waste collection and separation system 100, the user input received or remaining in the alternate main vessel 122 is combined with water with a flush event to form a combined waste that can be routed to the solids separator 106 by actuating the main valve 116. For example, a waste event that includes at least toilet paper, the mixed waste contents of the alternate main vessel 122 can be routed to the solids separator 106 by generating a weak vacuum in the solids separator 106 by activation of the vacuum pump 112. Once a predetermined vacuum pressure is achieved, the main valve 116 can be opened and the waste transported to into the solids separator 106.

The controller 110 can be configured to control or operate additional elements for the system 101. For example, the system 101 can also comprise valves, pumps, motors, sensors, and the like (not shown) to control and facilitate the operation of the system, including transporting urine from the urine tank 126. In some examples, a urine tank 126 can be included in the human waste collection and separation system 101 having the alternate main vessel 122. A sensor can be positioned at the urine tank 126 to monitor the level of liquid in the urine tank. In some examples, a pump can be provided to facilitate the movement of the yellow stream from the urine tank 126 to an outlet of the human waste collection and separation system 101.

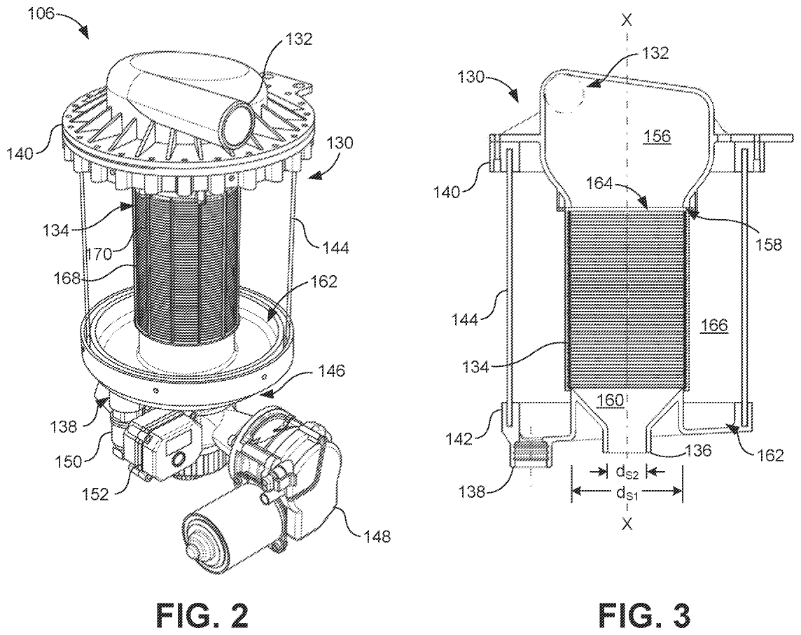

Referring to FIGS. 2 and 3 an example of a frontend solids separator 106 is illustrated. As shown in FIG. 2, an example solids separator 106 includes a vacuum tank 130 can include an inlet 132, a separating filter 134, a solids outlet 136, and a liquid outlet 138. The vacuum tank 130 having a top portion 140, a base 142, and a cylindrical wall 144. The solids separator 106 can also include a first valve 146 and a first actuator 148 for the solids outlet 136 and a second valve 150 and a second actuator 152 for the liquids outlet 138. The first valve 146 and second valve 150 can be two-way valves.

In FIG. 3, a cross section of the vacuum tank 130 is shown. The vacuum tank 130 comprises an inlet chamber 156 formed within the vacuum tank 130 at the top portion 140. The inlet chamber 156 comprising the inlet 132 and a chamber outlet 158. The inlet chamber 156 has a tangential inlet 132 configured such that the volume stream is distributed to the walls and further distributed to the inside walls of the filter 134. A solids containment portion 160 is formed in the base 142 of the vacuum tank 130 and positioned centrally within the vacuum tank 130. The solids containment portion 160 includes the solids outlet 136. The solids containment portion 160 is configured to hold a separated solids volume of the combined waste that is controlled by the geometry. For example, the solids containment portion 160 can have a conical shape, with a first diameter (dₛ₁) substantially equal to the diameter of the separating filter 134 and a second diameter (dₛ₂) at the chamber outlet 158. For example, the diameters of 160 can vary and conical angle can vary between 0 degrees and 90 degrees to a control the volume and composition of the separated solids in 160. For example, the total solids (TS) of the solids portion released via the solids outlet 136 can be controlled in the volume of the containment portion 160 by diluting the solids contained. A liquids containment portion 162 is formed in the base 142 of the vacuum tank 130 and contained within the vacuum tank 130 surrounding the solids containment portion 160. The liquids containment portion 162 includes a liquids outlet 138. The liquids containment portion 162 is configured to hold a separated liquid portion of the combined waste portion. The separating filter 134 having a cylindrical tubular shape and extending from the chamber outlet 158 to the solids containment portion 160. The separating filter 134 forming a central separation volume 164 within the vacuum tank 130.

The inlet chamber 156 is configured to receive the combined waste via the inlet 132 and to direct the combined waste to the central separation volume 164. The liquid portion of the combined waste is allowed to flow through the separating filter 134 to an outer portion 166 surrounding the central separation volume 164 and collects in the liquid containment portion 162 of the base 142. The solids portion of the combined waste is contained within the central separation volume 164 and collected in the solids containment portion 160 of the base 142. The solids containment portion 160 can have funnel or conical shape to direct the solids portion of the combined waste to the solids outlet 136. The solids portion collected in the solids containment portion 160 can be released via outlet 136 with overpressure or with gravity. For example, the vacuum pressure of the overpressure can be about 0.5 bar. As will be further described, the solids portion collected in the solids containment portion 160 can be released via solids outlet 136 by actuating the first valve 146. The base 142 of the vacuum tank 130 has an inclined base within the liquids containment portion 162 such that a flow of the liquid portion of the combined waste collected in the liquids containment portion 162 is directed to the liquids outlet 138 by gravity. The liquid portion collected in the liquids containment portion 162 can be released via liquids outlet 138 by actuating the second valve 150. When the evacuation of the vacuum tank 130 is done by overpressure, the liquid is drained from the liquid containment portion 162 before overpressure is applied.

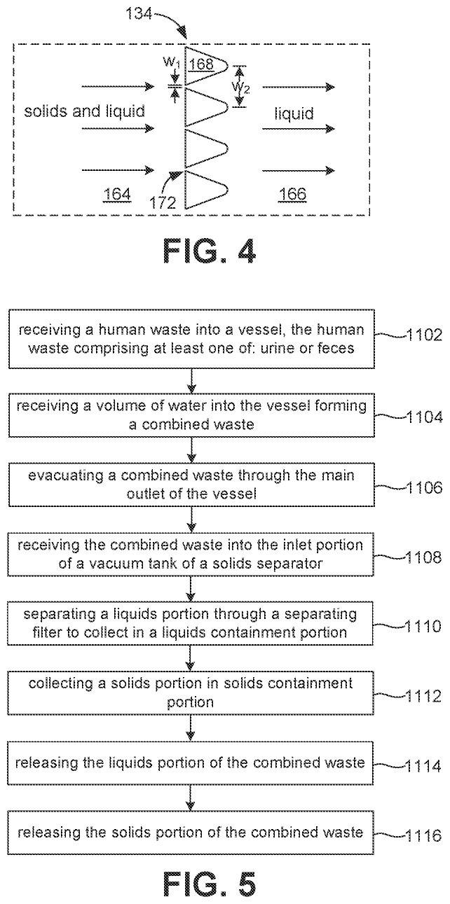

The separating filter 134 can comprise profile wires 168 mounted on supports 170 and aligned to form slots 172 (FIG. 4) configured to retain solids in the central separation volume 164 and allow liquids to pass through to the outer portion 166 of the vacuum tank 130. The profile wires 169 can be rods formed with a specified profile cross section. In an example, each profile wire can have cross section with a wedge shape. In other examples, the profile wire can have a circular, rectangular, triangular, or other specified shape. The separating filter 134 can be configured with the profile wires 168 spaced with to for slots with a predetermined minimum width (w₁) on at least one side. The size and shape of the slots may vary based on the configuration. For example, the profile wires 168 can be arranged to form slots 172 between the profile wires 168, such that if the arrangement is flat, the slots have a predetermined minimum width (w₁) on at least one side of the arrangement.

In the example shown in FIGS. 2 and 3, the supports 170 are oriented in a direction substantially parallel to the central axis (X) of the vacuum tank 130, and the profile wires 168 of the separating filter 134 are oriented in a substantially horizontal direction, such that the slots 172 between the profile wires 168 are oriented in a direction substantially perpendicular to the central axis (X) of the vacuum tank 130. In another example (not shown), the wedge wires 168 of the separating filter 134 are oriented in a direction substantially parallel to the central axis (X) of the vacuum tank 130, such that the slots between the profile wires 168 are oriented in a direction substantially parallel to the central axis of the vacuum tank 130.

In FIG. 4, a portion of the separating filter 134 is shown to illustrate the liquid separation of the combined waste. In one example, the separating filter 134 can be a wedge wire filter, although the design can be implemented and relied upon in other types and configurations of metal or wire filters. In this example, the separating filter 134 comprises a plurality of wires, each of the wires having a wedge shape or triangular cross-section. The plurality of wires can be arranged such that the separating filter 134 has V-shaped grooves extending from slots with a predetermined minimum width (w₁) between each pair of wedge wires at an inner circumference of the cylindrical tubular shape at the central separation volume 164 to wider openings (w₂) at an outer circumference of the cylindrical tubular shape at the outer portion 166. The shape of the wires allowing the liquid to pass while the solids are contained within the central separation volume 164 and directed to the solids containment portion 160 in the base 142 of the vacuum tank 130. For example, the controller 110 can also actuate pumps, motors, and valves to control of the vacuum tank 130. The controller 110 can actuate the vacuum pump 112 to evacuate the combined waste from the main vessel 102 or 122 into the inlet chamber 156 via the inlet 132. The inlet 132 and inlet chamber 156 are configured such that when the combined waste stream enters the inlet chamber 156, the velocity of combined waste stream is slowed by the geometry of the inlet chamber 156. The inlet chamber has a tangential inlet 132 so that the volume stream is distributed to the walls, such that the combined waste stream is guided in a spiral to the central separation volume 164 of the vacuum tank 130 and further distributed to the inside walls of the filter 134. The fluids can pass through the separating filter 134 and collect in the liquid containment portion 162 of the base 142.

For a urination event, the proportionally small amount of solids can collect in the solids containment portion 160; however, the solids can remain collected until a subsequent event with additional solids. For example, if a urination event is determined by user selection or a sensor, the controller 110 can actuate the second valve 150 to release the collected liquids via the liquid outlet 138. In some examples, for a urination event, an overpressure can be applied to the vacuum tank 130 to release any solids that remain collected in the solids containment portion 160 via solids outlet 136. For a defecation event, where a solids portion is collected in the solids containment portion 160 in the base 142 of the vacuum tank 130, the solids portion can be released via solids outlet 136 by gravity or by an overpressure. For example, an overpressure can be applied to the vacuum tank 130 after the liquids portion collected in the liquid containment portion 162 of the base 142 has been released. The liquid portion of the combined waste collected in the liquid containment portion 162 can be released via the liquid outlet 138 by flow due to gravity after opening the second valve 150. The vacuum pump 112 can be reversed for overpressure or separate pumps can be used to pressurize the content of the vacuum tank 130. The solids portion of the combined waste collected in the solids containment portion 160 can be released via the solids outlet 136 after a pressure is applied to the vacuum tank. A first actuator 148 can be configured to operate a first valve at the solids outlet 136 and a second actuator 152 can be configured to operate a second valve 150 at the liquid outlet 138. The controller can be configured to open the first valve 146 when an overpressure is applied to the vacuum tank 130, releasing the solids portion of the combined waste collected in the solids containment portion 160.

The solids separator 106 is configured with a two-way valve 146 at the solids outlet 136 that is actuated by a motor. In another example, the two-way valve 146 can be actuated by an overpressure. For example, the two-way valve 146 can be a ball valve. As the contents of the vacuum tank are pressurized, the two-way valve can be opened to direct the solids stream for treatment of the feces and other solids in one or more modules of a larger system. For example, the solids stream output can be delivered as the input into a feces treatment module or system. After the pressurization of the vacuum tank and release of the solids portion, the liquid portion can be released by opening the two-way valve. The liquid portions are allowed to passively drain from the liquid containment portion. The base of the liquid containment portion having an incline to direct the liquid to the liquid outlet. The liquid stream released from the liquid outlet can be directed for treatment in one or more modules of a larger system. For example, the liquid stream output can be delivered as the input into a liquid treatment module or system. For example, the liquid stream can be directed to a buffer system and/or urine and wastewater treatment system. In an example, the liquid portion separated from the combined waste comprises less than 5% dry solids content, the solids content comprising feces and toilet paper. In an example, the solids portion separated from the combined waste comprises about 1%-25% dry solids content, the solids content comprising feces and toilet paper.

The frontend can also include a touchless human machine interface configured to communicate the status of the toilet system to the user. For example, the human machine interface can be integrated into the user interface pane and can indicate that the toilet system is ready to use, requires maintenance, is shutdown, etc. The human waste collection and separation system can be connected to a power source and, in some examples, can also include a backup battery in the case of intermittent power or temporary power loss. In some examples, the human waste collection and separation system or complete toilet system can be powered by a battery or off-grid energy systems.

FIG. 5 shows an example method for collection and separation of human waste using the system of FIG. 1A as described herein. At box 1102, receive a human waste into a vessel. The human waste comprising at least one of a liquid waste and a solids waste. The liquid waste comprising at least one of: urine and rinse water. The solids waste comprising at least one of: feces and toilet incidentals, such as toilet paper. The human waste comprising at least one of: urine, feces, and toilet incidentals.

In some examples, when the vessel includes a urine diverter 124, such as system 101 as shown in FIG. 1B, the method can also include diverting a bypass portion of the urine via a urine diverter formed in the vessel. For example, the bypass liquid outlet can be connected to a urine tank to hold the liquid containing mostly urine before releasing a yellow stream for further treatment. For example, for a urination event, the liquid waste can comprise mostly urine and some water and be diverted from the main vessel outlet via the urine diverter to a yellow stream outlet.

At box 1104, receive a volume of flush water for a human waste event sufficient to wash any residual urine, residual feces, and toilet paper to the main outlet of the main vessel. In some examples, a predetermined volume of water is used for any human waste event. In some examples, a first predetermined volume can be used for a urination event and a second predetermined volume can be used for a defecation event. For example, the first predetermined volume can be considered small, relative to the volume of water needed for a defecation event.

At box 1106, evacuate the combined waste, including the flush water, via the main outlet of the main vessel. A vacuum pump can be used to form a weak vacuum to transport the combined waste to a vacuum tank of the solids separator.

At box 1108, receive the combined waste into the inlet portion of the vacuum tank. The inlet portion shaped to decelerate and direct the combined waste into a separation volume within the vacuum tank. The inlet to the solids separator can be positioned to receive the combined waste tangentially and direct the combined waste along a circumferential interior wall of the inlet chamber to decelerate and damper the input. For example, the inlet can be positioned off center, such that the combined waste stream received flows in along the interior wall inlet chamber, and in a circular motion through the inlet chamber, where the chamber is shaped to guide the combined waste stream to the chamber outlet. For example, the inlet is off set from the center and formed such that the input stream is guided in a spiral.

At box 1110, pass a liquid portion of the combined waste through the separating filter to collect the liquid in a liquid containment portion of the base. The base having a solids containment portion formed in the base of the vacuum tank and positioned centrally within the vacuum tank and a liquid containment portion formed in the base and surrounding the solids containment portion. As the combined waste stream is received into the separation volume within the separating filter, some of the liquid having lateral directional motion will pass through the separating filter. The liquid of combined waste received into the separation volume can also be directed to flow through the separating filter by gravity.

At box 1112, collect the solids portion of the combined waste in the solids containment portion of the base. The solids containment volume configured to hold a separated solids portion of the combined waste as the liquid portions pass through to a volume between the separating filter and the vacuum tank wall. The solids portion of the combined waste remaining within the separating filter as the combined waste settles by gravity. The solids containment portion can have a funnel shape to contain and direct the solids to the solids outlet, while allowing excess liquid to collect in the liquid containment portion.

At box 1114, release the solids portion of the combined waste that has collected in the solids containment portion via the solids outlet. An overpressure can be applied to the vacuum tank such that some remaining liquids within the separation volume are forced with air through the separating filter to collect in the liquid containment portion of the base. The solids separator is configured with a two-way valve at the solids outlet that is actuated by a motor. As the contents of the vacuum tank are pressurized, the two-way valve can be opened to direct the solids stream for treatment of the feces and other solids in one or more modules of a larger system. For example, the solids stream output can be delivered as the input into a feces treatment module or system.

At box 1116, release a liquid portion of the combined waste that has collected in the liquid containment portion formed in the base of the vacuum tank. The solids separator configured with a two-way valve at the liquid outlet operated by an actuator. Prior the pressurization of the vacuum tank and release of the solids portion, the liquid portion can be released by opening the two-way valve. The liquid portion are allowed to passively drain from the liquid containment portion. The base of the liquid containment portion having an incline to direct the liquid to the liquid outlet. The liquid stream release from the liquid outlet can be directed for treatment in one or more modules of a larger system. For example, the liquid stream output can be delivered as the input into a liquid treatment module or system. For example, the liquid stream can be directed to a buffer system and/or urine and wastewater treatment system.

The human waste collection and separation system 100 or 101 can be configured for use in various systems and applications. In some examples, the solids separator 106 can be used in other applications and can be configured to separate a combined waste received from a source other than a toilet. As discussed above, the human waste collection and separation system 100 or 101, or the solids separator 106, can be a separation system configured for use in a stand-alone non-sewered toilet system. For example, in a stand-alone non-sewered toilet system, a frontend system configured to receive human waste can comprise the human waste collection and separation system 100 or 101. The human waste collection and separation system 100 or 101 can be configured to operate as part of and integrate with other systems of the stand-alone non-sewered toilet system, such as a liquid treatment system, a solids treatment system, and/or another separation system.

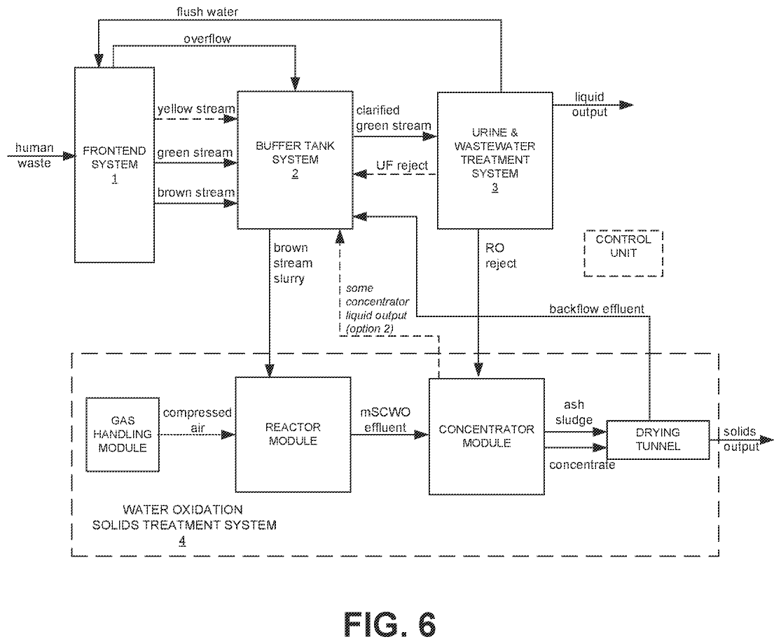

FIG. 6 illustrates an example schematic of a non-sewered single unit toilet system that includes a frontend system 1, a buffer tank system 2, a urine and wastewater system 3, and a water oxidation solids treatment system 4. In this example, the frontend system 1 can be a separation system that comprises the human waste collection and separation system 100 or 101 described herein. For example, the frontend system 1 can be configured to capture human waste and to separate the mixed waste stream into at least one of a green stream and a brown stream. In an example using system 101, a yellow stream can be also separated. The separated green, brown, and/or yellow streams can be further processed by a buffer tank system 2. The buffer tank system 2 can be configured to output a clarified green stream to a urine and wastewater treatment system 3 and a brown stream slurry to the water oxidation solids treatment system 4. Further, the buffer tank system 2 can receive input from one or more of the systems or modules of the non-sewered single unit toilet system for additional processing. The non-sewered single unit toilet system can be configured to deliver a treated liquid output and a treated solids output. Clean water and/or treated water can be further used in the system for flush water in the frontend system 1 or used for processing in one or more of the systems or modules. The single unit toilet system can further comprise control unit comprising at least one controller for the operation of the system and/or one or more modules of the system, including valves, pumps, motors, sensors, and other devices.

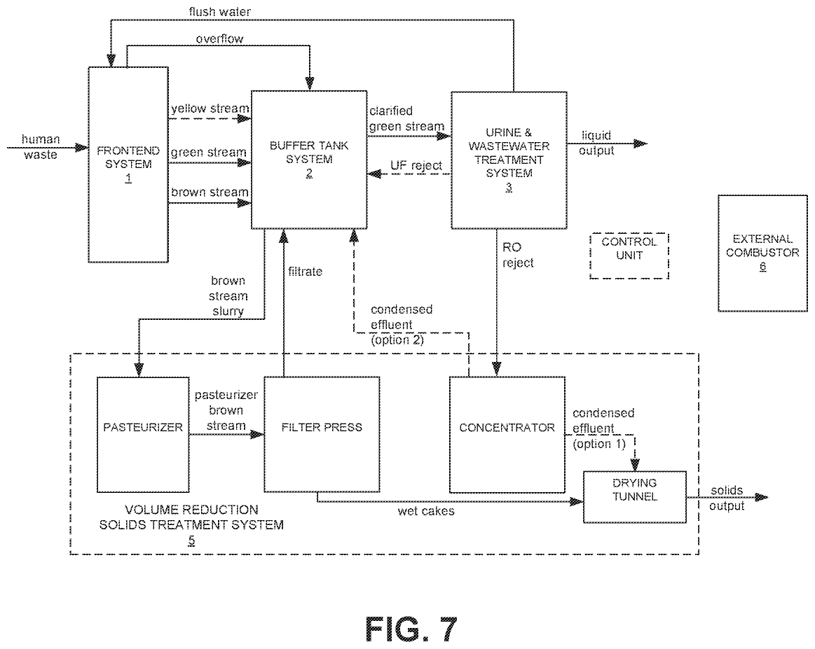

FIG. 7 illustrates another example schematic of a non-sewered single unit toilet system that includes a frontend system 1, a buffer tank system 2, a urine and wastewater system 3, a volume reduction solids treatment system 5, and external combustor 6. In this example, the frontend system 1 can be a separation system that comprises the human waste collection and separation system 100 or 101 described herein. As shown the frontend system 1 can be modular and configured to adapt to another configuration of non-sewered single unit toilet system. Although there are similar system in both FIG. 6 and FIG. 7, a different solids treatment module is shown in FIG. 8 as a volume reduction solids treatment system 5. Similar to FIG. 6, the frontend system 1 can be configured to capture the human waste and to separate the mixed waste stream into at least one of a green stream and a brown stream. In an example using human waste collection and separation system 101, a yellow stream can be also separated. The separated green, brown, and/or yellow streams can be further processed by a buffer tank system 2. The buffer tank system 2 can be configured to output a clarified green stream to a urine and wastewater treatment system 3 and a brown stream slurry to the volume reduction solids treatment system 5. The single unit toilet system can be configured to deliver a treated liquids output and a treated solids output. The single unit toilet system can further comprise a control unit comprising at least one controller for the operation of the system and/or one or more modules of the system, including valves, pumps, motors, sensors, and other devices. In this example, an external combustor 6 can also be part of the non-sewered single unit toilet system can be configured to receive the treated solids output.

### ASPECTS

The following list of exemplary aspects supports and is supported by the disclosure provided herein.

Aspect 1. A solids separator for separating a combined human waste, the solids separator comprising:
a vacuum tank having a top portion, a base, and a cylindrical wall, the vacuum tank, comprising:
an inlet chamber formed within the vacuum tank at the top portion, the inlet chamber comprising an inlet and a chamber outlet;
a solids containment portion formed in the base of the vacuum tank and positioned centrally within the vacuum tank, the solids containment portion comprising a solids outlet, the solids containment portion configured to hold a separated solids portion of the combined waste;
a liquid containment portion formed in the base of the vacuum tank and contained within the vacuum tank surrounding the solids containment portion, the liquid containment portion comprising a liquids outlet, the liquid containment portion configured to hold a separated liquid portion of the combined waste portion;
a separating filter having a cylindrical tubular shape and extending from the chamber outlet to the solids containment portion, the separating filter forming a central separation volume within the vacuum tank; and
wherein the inlet chamber is configured to receive the combined waste via an inlet such that the combined waste is guided in a spiral about an interior surface of the inlet chamber and directed to the central separation volume, the liquid portion of the combined waste allowed to flow through the separating filter to an outer portion surrounding the central separation volume and collect in the liquid containment portion of the base, the solids portion of the combined waste contained within the central separation volume and collected in the solids containment portion of the base.

Aspect 2. The solids separator of aspect 1, wherein the separating filter comprises a plurality of profile wires, each of the profile wires having a specified cross-section, the plurality of profile wires arranged at a regular interval to form a plurality of grooves extending from slits between the profile wires at an inner circumference of the cylindrical tubular shape to wider openings at an outer circumference of the cylindrical tubular shape.

Aspect 3. The solids separator of aspect 1 or 2, wherein the base of the vacuum tank has an inclined base within the liquid containment portion such that a flow of the liquid portion of the combined waste collected in the liquid containment portion of the base is directed to the liquid outlet.

Aspect 4. The solids separator of any one of aspects 1-3, wherein the solids containment portion is funnel or conical shaped to direct the solids portion of the combined waste to the solids outlet.

Aspect 5. The solids separator of any one of aspects 1-4, wherein the solids portion of the combined waste collected in the solids containment portion is released via the solids outlet after a pressure is applied to the vacuum tank.

Aspect 6. The solids separator of any one of aspects 1-5, wherein the liquid portion of the combined waste collected in the liquid containment portion is released via the liquids outlet by gravity.

Aspect 7. The solids separator of any one of aspects 1-6, further comprising a first actuator configured to operate a first valve at the solids outlet and a second actuator configured to operate a second valve the liquids outlet.

Aspect 8. The solids separator of any one of aspects 1-7, wherein the first valve configured to open when an overpressure is applied to the vacuum tank, releasing the solids portion of the combined waste collected in the solids containment portion.

Aspect 9. The solids separator of any one of aspects 1-8, wherein the second valve is actuated after the first valve, releasing the liquid portion of the combined waste collected in the liquid containment portion.

Aspect 10. A system, comprising:
a vessel comprising a main outlet, the vessel configured to receive human waste comprising at least one of: urine and feces;
a flush tank configured to deliver a volume of flush water to the vessel to form a combined waste with the human waste within the vessel; and
the solids separator of any one of aspects 1-9.

Aspect 11. The system of aspect 10, wherein a weak vacuum is applied to vacuum tank of the solids separator by a vacuum pump to evacuate the vessel as the main valve is actuated.

Aspect 12. The system of aspect 10 or 11, further comprising a user interface configured for a user to select a flush mode comprising at least one of: a urine event mode and a defecation event mode.

Aspect 13. The system of any one of aspects 10-12, wherein the vessel comprises a urine diverter and in response to a urination event, a bypass portion of urine is passively directed to a bypass outlet of the vessel and to a urine tank.

Aspect 14. A method for collection and separation human waste using the solids separator of any one of aspects 1-9, the method comprising:
receiving a human waste into a vessel having a main outlet, the human waste comprising at least one of: urine and feces;
receiving a volume of flush water forming a combined waste within the vessel;
evacuating the combined waste through a main outlet of the vessel into the solids separator; and
separating the combined waste into a liquid portion comprising mostly fluid with some solids and a solids portion comprising mostly solids and some fluid.

Aspect 15. The method of aspect 14, wherein evacuating the combined waste comprises: using a vacuum pump to form a weak vacuum to transport the combined waste to the solids separator.

Aspect 16. The method of aspect 14 or 15, wherein the combined waste is received into the inlet chamber of the solids separator via the inlet, the inlet being positioned to receive the combined waste tangentially and direct the combined waste along a circumferential interior wall of the inlet chamber to decelerate the combined waste.

Aspect 17. The method of any one of aspects 14-16, wherein the solids portion of the combined waste collected in the solids containment portion is released via the solids outlet after a pressure is applied to the vacuum tank.

Aspect 18. The method of any one of aspects 14-17, wherein the liquid portion separated from the combined waste comprises less than 5% dry solids content, the solids content comprising at least one of feces and toilet paper.

Aspect 19. The method of any one of aspects 14-18, wherein the solids portion separated from the combined waste comprises about 1%-25% dry solids content, the solids content comprising at least one of feces and toilet paper.

Aspect 20. The method of aspect any one of aspects 14-19, wherein the volume of flush water comprises a predetermined amount of flush water based whether the human waste received is due to a urination event or a defecation event.

The features of the embodiments described herein are representative and, in alternative embodiments, certain features and elements can be added or omitted. It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

1. A solids separator for separating a combined human waste, the solids separator comprising:
a vacuum tank having a top portion, a base, and a cylindrical wall, the vacuum tank, comprising:
an inlet chamber formed within the vacuum tank at the top portion, the inlet chamber comprising an inlet and a chamber outlet;
a solids containment portion formed in the base of the vacuum tank and positioned centrally within the vacuum tank, the solids containment portion comprising a solids outlet, the solids containment portion configured to hold a separated solids portion of the combined waste;
a liquid containment portion formed in the base of the vacuum tank and contained within the vacuum tank surrounding the solids containment portion, the liquid containment portion comprising a liquids outlet, the liquid containment portion configured to hold a separated liquid portion of the combined waste portion;
a separating filter having a cylindrical tubular shape and extending from the chamber outlet to the solids containment portion, the separating filter forming a central separation volume within the vacuum tank; and
wherein the inlet chamber is configured to receive the combined waste via an inlet such that the combined waste is guided in a spiral about an interior surface of the inlet chamber and directed to the central separation volume, the liquid portion of the combined waste allowed to flow through the separating filter to an outer portion surrounding the central separation volume and collect in the liquid containment portion of the base, the solids portion of the combined waste contained within the central separation volume and collected in the solids containment portion of the base.

2. The solids separator of claim 1, wherein the separating filter comprises a plurality of profile wires, each of the profile wires having a specified cross-section, the plurality of profile wires arranged at a regular interval to form a plurality of grooves extending from slits between the profile wires at an inner circumference of the cylindrical tubular shape to wider openings at an outer circumference of the cylindrical tubular shape.

3. The solids separator of claim 1, wherein the base of the vacuum tank has an inclined base within the liquid containment portion such that a flow of the liquid portion of the combined waste collected in the liquid containment portion of the base is directed to the liquids outlet.

4. The solids separator of claim 1, wherein the solids containment portion is funnel or conical shaped to direct the solids portion of the combined waste to the solids outlet.

5. The solids separator of claim 1, wherein the solids portion of the combined waste collected in the solids containment portion is released via the solids outlet after a pressure is applied to the vacuum tank.

6. The solids separator of claim 1, wherein the liquid portion of the combined waste collected in the liquid containment portion is released via the liquids outlet by gravity.

7. The solids separator of claim 1, further comprising a first actuator configured to operate a first valve at the solids outlet and a second actuator configured to operate a second valve the liquids outlet.

8. The solids separator of claim 7, wherein the first valve is configured to open when an overpressure is applied to the vacuum tank, releasing the solids portion of the combined waste collected in the solids containment portion.

9. The solids separator of claim 7, wherein the second valve is actuated after the first valve, releasing the liquid portion of the combined waste collected in the liquid containment portion.

10. A system, comprising:
a vessel comprising a main outlet, the vessel configured to receive human waste comprising at least one of: urine and feces;
a flush tank configured to deliver a volume of flush water to the vessel to form a combined waste with the human waste within the vessel; and
the solids separator of claim 1.

11. The system of claim 10, wherein a weak vacuum is applied to vacuum tank of the solids separator by a vacuum pump to evacuate the vessel as the main valve is actuated.

12. The system of claim 10, further comprising a user interface configured for a user to select a flush mode comprising at least one of: a urine event mode and a defecation event mode.

13. The system of claim 10, wherein the vessel comprises a urine diverter and in response to a urination event, a bypass portion of urine is passively directed to a bypass outlet of the vessel and to a urine tank.

14. A method for collection and separation human waste using the solids separator of claim 1, the method comprising:
receiving a human waste into a vessel having a main outlet, the human waste comprising at least one of: urine and feces;
receiving a volume of flush water forming a combined waste within the vessel;
evacuating the combined waste through a main outlet of the vessel into the solids separator; and
separating the combined waste into a liquid portion comprising mostly fluid with some solids and a solids portion comprising mostly solids and some fluid.

15. The method of claim 14, wherein evacuating the combined waste comprises: using a vacuum pump to form a weak vacuum to transport the combined waste to the solids separator.

16. The method of claim 14, wherein the combined waste is received into the inlet chamber of the solids separator via the inlet, the inlet being positioned to receive the combined waste tangentially and direct the combined waste along a circumferential interior wall of the inlet chamber to decelerate the combined waste.

17. The method of claim 14, wherein the solids portion of the combined waste collected in the solids containment portion is released via the solids outlet after a pressure is applied to the vacuum tank.

18. The method of claim 14, wherein the liquid portion separated from the combined waste comprises less than 5% dry solids content, the solid content comprising at least one of feces and toilet paper.

19. The method of claim 14, wherein the solids portion separated from the combined waste comprises about 1%-25% dry solids content, the solids content comprising at least one of feces and toilet paper.

20. The method of claim 14, wherein the volume of flush water comprises a predetermined amount of flush water based on whether the human waste received is due to a urination event or a defecation event.
